(19) United States
(12) Patent Application Publication
(10) Pub. No.: US 2026/0024268 A1
(43) Pub. Date: Jan. 22, 2026

(54) Rendering Video Of A Scene Using Three-Dimensional Gaussians

(71) Applicant: Shenzhen Yinwang Intelligent Technologies Co., Ltd., Shenzhen (CN)

(72) Inventors: Guile Wu, Markham (CA); Tongtong Cao, Markham (CA); Bingbing Liu, Beijing (CN)

(21) Appl. No.: 18/779,232

(22) Filed: Jul. 22, 2024

(51) Int. Cl. G06T 15/08; G06T 13/20; G06T 15/20

(52) U.S. Cl. CPC G06T 15/08; G06T 13/20; G06T 15/20; G06T 2210/56

(57) ABSTRACT

A set of images of a scene re received. Each image includes temporal data and spatial data relating to the scene. Based on the spatial data of each image, three-dimensional (3D) Gaussian splatting data is generated. The temporal data of each image and the 3D Gaussian splatting data are inputted to a neural network to generate spatial-temporal 3D Gaussian embeddings. Offset data based on the spatial-temporal 3D Gaussian embeddings is generated. The video of the scene is rendered based on the 3D Gaussian splatting data and the offset data, allowing for improved rendering of video of the scene.

### FIELD

The present disclosure relates to computer graphics processing and in particular to methods and devices for rendering video of a scene using three-dimensional (3D) Gaussians.

### BACKGROUND

3D Gaussian splatting is a technique used in computer graphics and vision to represent and render 3D scenes using point clouds composed of Gaussian distributions. This method is particularly useful for efficiently handling and visualizing complex 3D data, and can be used to enable the rendering of photo-realistic results in real time. Simulations based on 3D Gaussian splatting, such as autonomous driving scene simulations, have shown great effectiveness and efficiency over approaches based on conventional neural radiance fields (NeRF).

However, in order to simulate both the background and foreground information contained within a scene, existing 3D Gaussian splatting-based simulations generally focus on 3D Gaussian representations that are based only on spatial information. As a result, the simulated results of these approaches contain many artifacts and fail to render many important details.

### SUMMARY

According to a first aspect of the disclosure, there is provided a method of rendering video of a scene, comprising: receiving a set of images of the scene, wherein each image comprises temporal data and spatial data relating to the scene; generating, based on the spatial data of each image, three-dimensional (3D) Gaussian splatting data; inputting the temporal data of each image and the 3D Gaussian splatting data to a neural network to generate spatial-temporal 3D Gaussian embeddings; generating offset data based on the spatial-temporal 3D Gaussian embeddings; and rendering the video of the scene based on the 3D Gaussian splatting data and the offset data. As a result, effective composite Gaussian representations (i.e., Gaussian representations containing both spatial information and temporal information) may be constructed, and this may allow for improved rendering of video of the scene.

Rendering the video of the scene may comprise: combining the 3D Gaussian splatting data with the offset data to generate spatial-temporal 3D Gaussian representations of the scene; and rendering the video of the scene by inputting the spatial-temporal 3D Gaussian representations to a rasterizer.

Generating the 3D Gaussian splatting data may comprise generating the 3D Gaussian splatting data using 3D point cloud reconstruction.

Generating the 3D Gaussian splatting data may comprise inputting the spatial data of each image to a machine learning model trained to generate 3D Gaussian splatting data based on spatial data from one or more images.

Each image may further comprise viewpoint data of the scene. Generating the offset data may be further based on the viewpoint data. Generating the offset data may comprise inputting the viewpoint data to a neural network to generate one or more spherical harmonics offset parameters. Spherical harmonics are anisotropic, meaning they produce different colors for the same location when viewed from different directions, which may enhance the realism and accuracy of the rendered video.

The neural network may be a multi-layer perceptron.

Generating the offset data may comprise inputting the spatial-temporal 3D Gaussian embeddings to one or more neural networks.

At least one of the one or more neural networks may be a multi-layer perceptron.

Each of the one or more neural networks may be a multi-layer perceptron.

Generating the 3D Gaussian splatting data may comprise generating one or more of: one or more 3D Gaussian position parameters; one or more 3D Gaussian scale parameters; one or more 3D Gaussian rotation parameters; and one or more 3D Gaussian opacity parameters. Generating the offset data may comprise inputting one or more of: the one or more 3D Gaussian position parameters to a neural network to generate one or more position offset parameters; the one or more 3D Gaussian scale parameters to a neural network to generate one or more scale offset parameters; the one or more 3D Gaussian rotation parameters to a neural network to generate one or more rotation offset parameters; and the one or more 3D Gaussian opacity parameters to a neural network to generate one or more opacity offset parameters.

Generating the 3D Gaussian splatting data may comprise: identifying, within the spatial data of each image: foreground spatial data relating a foreground of the scene; and background spatial data relating a background of the scene; generating, based on the background spatial data, background 3D Gaussian splatting data; and generating, based on the foreground spatial data, foreground 3D Gaussian splatting data. Since foreground objects are usually smaller than the background scene, processing the foreground and background separately may allow the model to more optimally render the video of the scene.

Generating the spatial-temporal 3D Gaussian embeddings may comprise: generating background spatial-temporal 3D Gaussian embeddings based on the temporal data of each image and the background 3D Gaussian splatting data; and generating foreground spatial-temporal 3D Gaussian embeddings based on the temporal data of each image and the foreground 3D Gaussian splatting data.

Generating the offset data may comprise: generating background offset data based on the background spatial-temporal 3D Gaussian embeddings; and generating foreground offset data based on the foreground spatial-temporal 3D Gaussian embeddings.

Rendering the video of the scene may comprise: combining the background 3D Gaussian splatting data with the background offset data to generate spatial-temporal 3D Gaussian representations of the background of the scene; combining the foreground 3D Gaussian splatting data with the foreground offset data to generate spatial-temporal 3D Gaussian representations of the foreground of the scene; and rendering the video of the scene by inputting the spatial-temporal 3D Gaussian representations of the background and the foreground of the scene to the rasterizer.

Generating the background offset data may comprise inputting the background spatial-temporal 3D Gaussian embeddings to a single neural network to generate the background offset data; and generating the foreground offset data may comprise inputting the foreground spatial-temporal 3D Gaussian embeddings to a single neural network to generate the foreground offset data.

Generating the offset data may comprise inputting the spatial-temporal 3D Gaussian embeddings to a single neural network to generate the offset data. This may allow for the model to comprehensively learn information from all Gaussian parameters to effectively generate offsets.

According to a further aspect of the disclosure, there is provided a non-transitory, computer-readable medium storing computer program code configured, when executed by one or more processors, to cause the one or more processors to perform any of the above-described methods.

According to a further aspect of the disclosure, there is provided a computing device comprising one or more graphics processors operable to render video of a scene by performing any of the above-described methods.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a computing device operable to render video of a scene, according to an embodiment of the disclosure;

FIG. 2 is a schematic flow diagram of a method of rendering video of a scene using 3D Gaussians, according to an embodiment of the disclosure;

FIG. 3 is a schematic flow diagram of a method of rendering video of a scene using 3D Gaussians while separately modelling spatial-temporal data for the background and the foreground, according to an embodiment of the disclosure;

FIG. 4 is a schematic flow diagram of a method of rendering video of a scene using 3D Gaussians, unified offset layers, and without encoding viewpoint data, according to an embodiment of the disclosure; and

FIG. 5 is a schematic flow diagram of the method of rendering video of a scene as shown in FIG. 2, showing in more detail different layers of the offset layers, according to an embodiment of the disclosure.

### DETAILED DESCRIPTION

The present disclosure seeks to provide novel methods of rendering video of a scene using 3D Gaussians. While various embodiments of the disclosure are described below, the disclosure is not limited to these embodiments, and variations of these embodiments may well fall within the scope of the disclosure which is to be limited only by the appended claims.

Embodiments of the disclosure are directed at novel data processing architectures configured to better learn spatial-temporal 3D Gaussian (or simply “Gaussian”) representations of data within scenes, for example autonomous driving scenes. Constructing effective composite Gaussian representations (i.e., Gaussian representations containing both spatial information and temporal information) for end-to-end simulations of the scene may allow for improved rendering of video of the scene. Therefore, embodiments of the disclosure are aimed at encoding background and foreground Gaussians (i.e., Gaussians respectively representing data in the background of the scene and in objects in the foreground of the scene) with spatial and temporal information. The spatial information may contain data relating to the position and color of the points that are generated during the creation of the Gaussians, whereas the temporal information (which may comprise timestamps, for example) may contain data relating to the specific point in time at which the associated spatial data was captured. According to some embodiments, the different architectures described herein may comprise single-stage, end-to-end training pipelines, rather than a multi-stage pipelines.

Generally, according to embodiments of the disclosure, there is described a method of rendering video of a scene. The method includes receiving a set of images of the scene, wherein each image comprises temporal data and spatial data relating to the scene. Temporal data may comprise data indicative of the point in time the image was captured or generated in relation to other images. For example, the temporal data may comprise a timestamp. Spatial data may include the image and 3D points extracted from the image. As described in further detail below, the 3D points may be derived by analyzing all the images together, with their initial positions estimated using, for example, 3D point cloud reconstruction software. The method further includes generating, based on the spatial data of each image, three-dimensional (3D) Gaussian splatting data. Splatting data may comprise 3D Gaussian learnable parameters, including position parameters, rotation parameters, scale parameters, opacity parameters, and spherical harmonics parameters.

The method further includes inputting the temporal data of each image and the 3D Gaussian splatting data to a neural network (which may be referred to as a spatial-temporal embedding layer) to generate spatial-temporal 3D Gaussian embeddings. Spatial-temporal 3D Gaussian embeddings may comprise the feature vectors of each 3D Gaussian extracted using the neural network. The method further includes generating offset data based on the spatial-temporal 3D Gaussian embeddings. For example, the spatial-temporal 3D Gaussian embeddings may be inputted to one or more other neural networks (which may be referred to as offset layers) to generate the offset data. Offset data may comprise offset values for each 3D Gaussian parameter. In particular, each 3D Gaussian parameter may have an associated offset value, and the resulting 3D Gaussian parameter value may be the sum of the original parameter value and its corresponding offset value. The method further includes rendering the video of the scene based on the 3D Gaussian splatting data and the offset data. For example, the resulting 3D Gaussians may be processed with a rendering module (such as a conventional Gaussian differentiable rasterizer) to render the video.

For example, using initial Gaussian representations for the background scene and foreground objects, a time encoding layer, a position encoding layer, and (optionally) a viewpoint encoding layer may be used to encode viewpoint-dependent spatial-temporal information relating to the Gaussian representations. As described above, this spatial-temporal information may then be passed to the spatial-temporal embedding layer (which may comprise a multi-layer perceptron) which generates the spatial-temporal Gaussian embeddings. The generated embeddings may then be input to one or more other neural networks (which may be referred to as offset layers) including a position offset layer, a scale offset layer, a rotation offset layer, an opacity offset layer, and a spherical harmonic layer. Each offset layer may comprise a multi-layer perceptron that learns the offset of each Gaussian over time. Residual connections may then be used to construct spatial-temporal Gaussian representations for splatting onto the rendered image sequence.

By using multiple offset layers to generate different offset values for different 3D Gaussian parameters, one or more offset values can be generated for specific 3D Gaussian parameters, rather than for all of them. For example, only the offset values for the 3D Gaussian position parameters may be generated, while leaving the other 3D Gaussian parameters unchanged.

Embodiments of the disclosure may be used to simulate outdoor or in-the-wild driving scenes, for example. Typical applicable scenarios include, for example, the following.
On an online cloud computing platform, the methods and architectures described herein can enable effective and efficient simulations of driving scenes. A typical pipeline may include: (1) first, a user selects or inputs real-world driving sequences and selects any of the architectures described herein to model to input; (2) next, the online cloud computing platform employs the selected architecture to train a unified, composite spatial-temporal Gaussian model to simulate the input in a simulator; and (3) next, the simulated results are outputted and the simulated model is optimized.
The methods and architectures described herein can also be used in different robotic simulation systems, and may support the optimization of data-driven simulators. Thus, different simulator systems may use the methods and architectures described herein as their basic model architecture to build their simulator so as to model spatial-temporal information for dynamic scene simulations. Such simulations may be integrated into software for distribution to end-users.

Embodiments of the disclosure will now be described in detail with reference to the drawings.

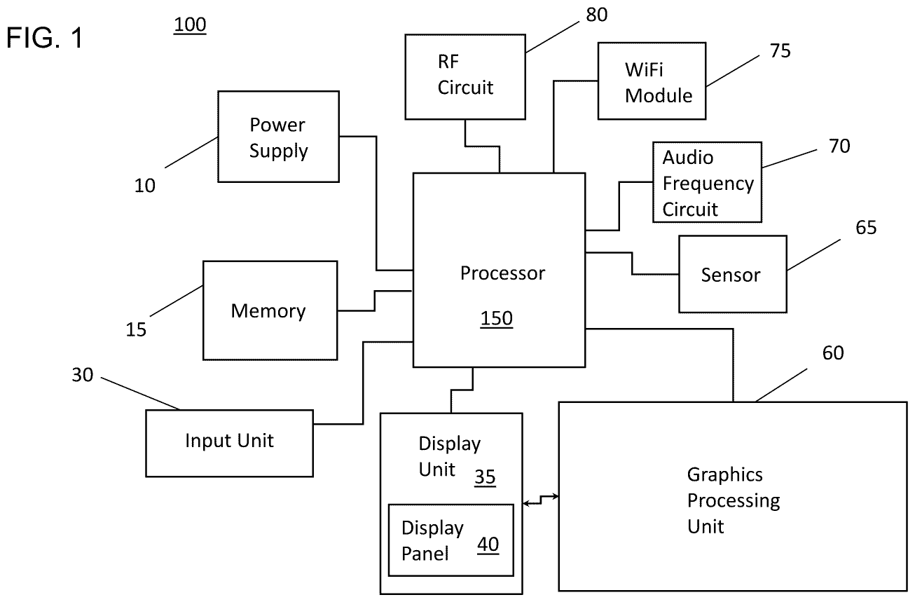

Embodiments of the disclosure may generally be used in connection with computer graphics processing. Furthermore, methods according to embodiments of the disclosure may be performed by electronic computing devices, and embodiments of the disclosure also include electronic computing devices configured to perform any of the methods described herein. An example of such an electronic computing device will now be described in further detail in connection with FIG. 1.

In some embodiments, the computing device may be a portable computing device, such as a tablet computer or a laptop with one or more touch-sensitive surfaces (for example, one or more touch panels). It should be further understood that, in other embodiments of this disclosure, the computing device may alternatively be a desktop computer with one or more touch-sensitive surfaces (for example, one or more touch panels).

For example, as shown in FIG. 1, the computing device according to embodiments of this disclosure may be a computing device 100. It should be understood that computing device 100 shown in the figure is merely an example of possible computing devices that may perform the methods described herein, and computing device 100 may have more or fewer components than those shown in the figure, or may combine two or more components, or may have different component configurations. Various components shown in the figure may be implemented in hardware, software, or a combination of hardware and software that include one or more signal processing and/or application-specific integrated circuits.

As shown in FIG. 1, computing device 100 may specifically include components such as one or more processors 150, a radio frequency (RF) circuit 80, a memory 15, display unit 35, one or more sensors 65 such as a fingerprint sensor, a wireless connection module 75 (which may be, for example, a Wi-Fi® module), an audio frequency circuit 70, an input unit 30, a power supply 10, and a graphics processing unit (GPU) 60. These components may communicate with each other by using one or more communications buses or signal cables (not shown in FIG. 1). A person skilled in the art may understand that a hardware structure shown in FIG. 1 does not constitute a limitation on computing device 100, and computing device 100 may include more or fewer components than those shown in the figure, may combine some components, or may have different component arrangements.

Processor 150 is a control center of computing device 100. Processor 150 is connected to each part of computing device 100 by using various interfaces and lines, and performs various functions of computing device 100 and processes data by running or executing an application stored in memory 15, and invoking data and an instruction that are stored in memory 15. In some embodiments, processor 150 may include one or more processing units. An application processor and a modem processor may be integrated into processor 150. The application processor mainly processes an operating system, a user interface, an application, and the like, and the modem processor mainly processes wireless communication. It should be understood that the modem processor does not have to be integrated in processor 150. For example, processor 150 may be a Kirin chip 970 manufactured by Huawei Technologies Co., Ltd. In some other embodiments of this disclosure, processor 150 may further include a fingerprint verification chip, configured to verify a collected fingerprint.

RF circuit 80 may be configured to receive and send a radio signal in an information receiving and sending process or a call process. Specifically, RF circuit 80 may receive downlink data from a base station, and then send the downlink data to processor 150 for processing. In addition, RF circuit 80 may further send uplink-related data to the base station. Generally, RF circuit 80 includes but is not limited to an antenna, at least one amplifier, a transceiver, a coupler, a low noise amplifier, a duplexer, and the like. In addition, RF circuit 80 may further communicate with another device through wireless communication. The wireless communication may use any communications standard or protocol, including but not limited to a global system for mobile communications, a general packet radio service, code division multiple access, wideband code division multiple access, long term evolution, an SMS message service, and the like.

Memory 15 is configured to store one or more applications and data. Processor 150 runs the one or more applications and the data that are stored in memory 15, to perform the various functions of computing device 100 and data processing. The one or more applications may comprise, for example, a computer game, or any other application that requires the rendering of computer graphics data for display on a display panel 40 of display unit 35. Memory 15 mainly includes a program storage area and a data storage area. The program storage area may store the operating system, an application required by at least one function, and the like. The data storage area may store data created based on use of computing device 100. In addition, memory 15 may include a high-speed random-access memory, and may further include a non-volatile memory, for example, a magnetic disk storage device, a flash memory device, or another non-volatile solid-state storage device. Memory 15 may store various operating systems such as an iOS® operating system developed by Apple Inc. and an Android® operating system developed by Google Inc. It should be noted that any of the one or more applications may alternatively be stored in a cloud, in which case computing device 100 obtains the one or more applications from the cloud.

Display unit 35 may include a display panel 40. Display panel 40 (for example, a touch panel) may collect a touch event or other user input performed thereon by the user of computing device 100 (for example, a physical operation performed by the user on display panel 40 by using any suitable object such as a finger or a stylus), and send collected touch information to another component, for example, processor 150. Display panel 40 on which the user input or touch event is received may be implemented on a capacitive type, an infrared light sensing type, an ultrasonic wave type, or the like.

Display panel 40 may be configured to display information entered by the user or information provided for the user, and various menus of computing device 100. For example, display panel 40 may further include two parts: a display driver chip and a display module (not shown). The display driver chip is configured to receive a signal or data sent by processor 150, to drive a corresponding screen to be displayed on the display module. After receiving the to-be-displayed related information sent by processor 150, the display driver chip processes the information, and drives, based on the processed information, the display module to turn on a corresponding pixel and turn off another corresponding pixel, to display a rendered computer model, for example.

For example, in this embodiment of this application, the display module may be configured by using an organic light-emitting diode (organic light-emitting diode, OLED). For example, an active matrix organic light emitting diode (active matrix organic light emitting diode, AMOLED) is used to configure the display module. In this case, the display driver chip receives related information that is to be displayed after the screen is turned off and that is sent by processor 150, processes the to-be-displayed related information, and drives some OLED lights to be turned on and the remaining OLEDs to be turned off, to display a rendered computer model.

Wireless connection module 75 is configured to provide computing device 100 with network access that complies with a related wireless connection standard protocol. Computing device 100 may access a wireless connection access point by using wireless connection module 75, to help the user receive and send an e-mail, browse a web page, access streaming media, and the like. Wireless connection module 75 provides wireless broadband internet access for the user. In some other embodiments, wireless connection module 75 may alternatively serve as the wireless connection access point, and may provide wireless connection network access for another electronic device.

Audio frequency circuit 70 may be connected to a loudspeaker and a microphone (not shown) and may provide an audio interface between the user and computing device 100. Audio frequency circuit 70 may transmit an electrical signal converted from received audio data to the loudspeaker, and loudspeaker the may convert the electrical signal into a sound signal for outputting. In addition, the microphone may convert a collected sound signal into an electrical signal, and audio frequency circuit 70 may convert the electrical signal into audio data after receiving the electrical signal, and may then output the audio data to radio frequency circuit 80 to send the audio data to, for example, a mobile phone, or may output the audio data to memory 15 for further processing.

Input unit 30 is configured to provide various interfaces for an external input/output device (for example, a physical keyboard, a physical mouse, a display externally connected to computing device 100, an external memory, or a subscriber identity module card). For example, a mouse is connected by using a universal serial bus interface, and a subscriber identity module (subscriber identity module, SIM) card provided by a telecommunications operator is connected by using a metal contact in a subscriber identity module card slot. Input unit 30 may be configured to couple the external input/output peripheral device to processor 150 and memory 15.

Computing device 100 may further include power supply module 10 (for example, a battery and a power supply management chip) that supplies power to the components. The battery may be logically connected to processor 150 by using the power supply management chip, so that functions such as charging management, discharging management, and power consumption management are implemented.

Computer device 100 further includes a GPU 60. Generally, GPU 60 is a specialized electronic circuit configured to rapidly manipulate and alter memory to accelerate the creation of images in a frame buffer intended for output to display unit 35. GPU 60 may comprise one or more shaders, such as a vertex shader. The vertex shader may be a three-dimensional shader that is executed once for each vertex of a computer model that is input to GPU 60. A purpose of a vertex shader is to transform each vertex's 3D position in virtual space to corresponding 2D coordinates at which the vertex will appear on display panel 40. The vertex shader can manipulate properties of the vertices of the computer model such as position, colour, and texture coordinates. GPU 60 may further comprise a fragment shader configured to determine the colour and other attributes of each “fragment” of the computer model, each fragment being a unit of rendering work affecting at most a single output pixel.

The following embodiments may all be implemented on an electronic device (for example, computing device 100) with the foregoing hardware structure.

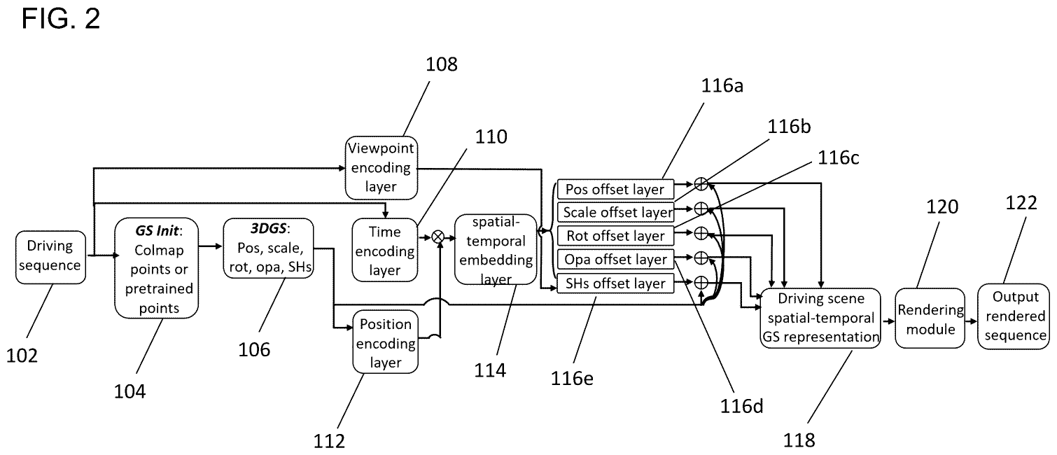

Turning to FIG. 2, there is shown a first flow diagram of a method of rendering video of a scene using 3D Gaussians, according to an embodiment of the disclosure.

At block 102, a set of images of the scene (such as a driving scene) is received. Each image contains both spatial information of the scene and temporal information of the scene. For example, each image may be associated with a timestamp, and the timestamps between successive images may indicate the amount of time that elapsed between when the images were captured.

At block 104, the set of images are inputted to 3D point cloud reconstruction software, such as COLMAP, VisualSFM, or OpenMVG. The 3D point cloud reconstruction software generates a set of 3D points, based on the images, that approximate a 3D model of the scene represented by the images. The 3D points that are generated are representative of both the background scene and foreground objects within the scene.

According to some embodiments, instead of using 3D point cloud reconstruction software, the set of images may be inputted to a machine learning model trained to generate 3D points based on input images. In order for the machine learning model to generate 3D points representative of foreground objects, multi-view images of objects within specific categories (e.g., vehicles, pedestrians, etc.) from arbitrary image sources may be used to train the machine learning model. While the 3D points generated by the machine learning model may not be directly representative of the foreground objects in the scene, the generated 3D points may provide a sufficiently stable initial representation of the objects so as to enable the subsequent learning of the composite spatial-temporal Gaussian representations, as described in further detail below. According to some embodiments, a trained machine learning model may be used to generate the 3D points for the background scene as well as.

At block 106, the 3D points are passed to a 3D Gaussian splatting model with learnable parameters, including position parameters, rotation parameters, scale parameters, opacity parameters, and spherical harmonics parameters. Spherical harmonics parameters may be used to generate RGB colors. Unlike scalar RGB colors, spherical harmonics exist in a high-dimensional space and are anisotropic, allowing them to produce a wider range of colors from different directions. The 3D Gaussian splatting model is configured to transform the position and color values of each 3D point into corresponding initial position and color values for the position parameter and the spherical harmonics parameter of each 3D Gaussian. Meanwhile, the values of the rotation parameters may be set to a predetermined value, such as [1, 0, 0, 0], the values of the scale parameters may be set to the distances between 3D points, and the values of the opacity parameters may be set to a predetermined value, such as 0.1.

At block 108, viewpoint (or “pose”) data associated with each input image is passed to a viewpoint encoding layer which encodes the viewpoint data associated with each image as a vector. The viewpoint data may include data relating to both the position of the camera that captured the image, as well as the direction in which the camera that captured the image was pointing.

At block 110, the temporal information associated with each image is passed to a time encoding layer which encodes the temporal data associated with each image as a vector.

At block 112, the 3D Gaussians (for both the background scene and the foreground objects) generated at block 106 are received at a position encoding layer which encodes the spatial information associated with each Gaussian as a vector.

Each encoding layer (viewpoint encoding layer 108, time encoding layer 110, and position encoding layer 112) is configured to apply a periodic encoding function with sine and cosine functions. In particular, time encoding layer 110 uses the periodic encoding function to transform the timestamp of each frame into a temporal encoding vector; position encoding layer 112 uses the periodic encoding function to transform the position parameter of each 3D Gaussian into a spatial encoding vector; and viewpoint encoding layer 108 uses the periodic encoding function to transform the camera's position and the camera's direction into a viewpoint encoding vector. For each 3D Gaussian, the time encoding vector is then concatenated with the position encoding vector.

At block 114, the concatenated vector is passed to a spatial-temporal embedding layer configured to learn unified spatial-temporal Gaussian embeddings, based on the concatenated vector. In the present embodiment, the spatial-temporal embedding layer comprises a two-layer neural network (or two-layer “perceptron”). In particular, the architecture of the neural network comprises a sequential arrangement of a linear layer, a rectified linear unit (ReLU) layer, and another linear layer.

The output of spatial-temporal embedding layer 114 is passed to a number of different offset layers, including a position offset layer (block 116a), a scale offset layer (block 116b), a rotation offset layer (block 116c), and an opacity offset layer (block 116d). Each of these offset layers comprises a two-layer neural network (or two-layer “perceptron”). In particular, the architecture of each neural network comprises a sequential arrangement of a linear layer, a rectified linear unit (ReLU) layer, and another linear layer. Each offset layer is configured to learn the offset of the respective parameter of each 3D Gaussian across time.

In addition, at block 116e, the output of the viewpoint encoding layer is passed to a spherical harmonic layer that also comprises a two-layer neural network (or two-layer “perceptron”). In particular, the architecture of the neural network comprises a sequential arrangement of a linear layer, a rectified linear unit (ReLU) layer, and another linear layer. Spherical harmonic layer 116e is configured to learn the offset of the color of each 3D Gaussian.

The output of each offset layer 116a-e is passed to a respective residual connection that adds the learned offset to the respective parameter learned by 3D Gaussian splatting model 106. The output of the residual connections is a composite spatial-temporal Gaussian representation of the scene (block 118).

At block 120, the composite spatial-temporal Gaussian representation is then passed to a rendering module (such as a conventional Gaussian differentiable rasterizer) which renders a video of the scene. The final output, at block 122, is a rendered video of the scene that is based on the original set of input images (block 102).

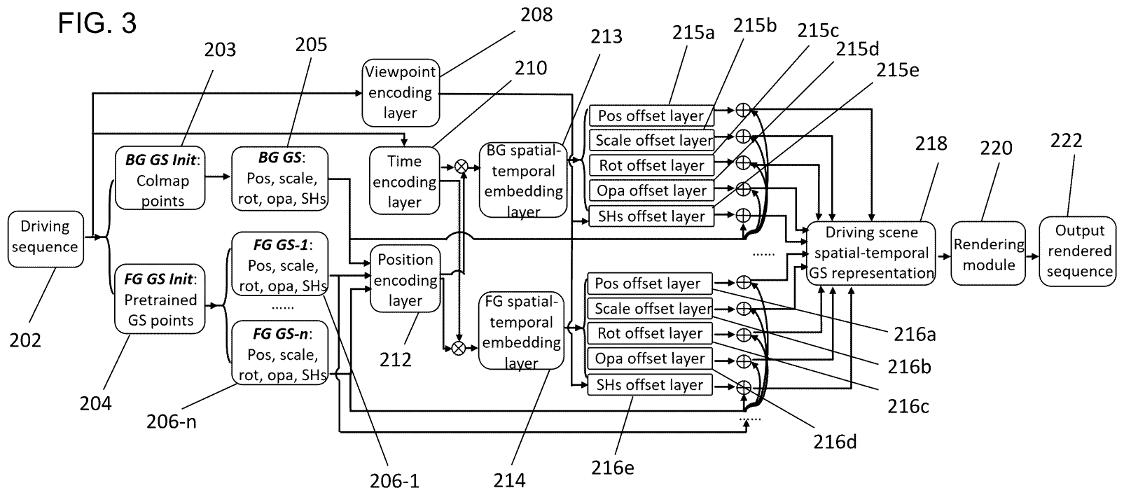

Turning to FIG. 3, there is shown a variant of the architecture described above in connection with FIG. 2. In particular, unlike FIG. 2, the spatial-temporal 3D Gaussians are separately modelled for the background scene and for foreground objects, instead of treating both background and foreground as a whole. This approach may allow for improved optimization of 3D Gaussian representations for the foreground objects and the background scene. When modeled together, foreground objects may be poorly represented because they are usually small compared to the large background scene.

At block 202, a set of images of the scene (such as a driving scene) is received. Each image contains both spatial information of the scene and temporal information of the scene. For example, each image may be associated with a timestamp, and the timestamps between successive images may indicate the amount of time that elapsed between when the images were captured.

At block 203, the set of images are inputted to 3D point cloud reconstruction software, such as COLMAP, VisualSFM, or OpenMVG. The 3D point cloud reconstruction software generates a set of 3D points, based on the images, that approximate a 3D model of the background of the scene represented by the images.

Unlike the architecture described in FIG. 2, in FIG. 3, the 3D point cloud reconstruction software generates only background points relating to the background of the scene (block 203), whereas foreground points relating to foreground objects (block 204) are generated using a machine learning model. This distinction may be useful because most foreground objects are dynamic and moving, making them unsuitable for the static nature of 3D point cloud reconstruction software. Generally, 3D point cloud reconstruction software may be best suited for generating points for static background objects. Additionally, using a machine learning model to generate foreground points may provide a better initial status for these objects, resulting in improved overall performance.

As described above in connection with FIG. 2, in order for the machine learning model to generate 3D points representative of foreground objects, multi-view images of objects within specific categories (e.g., vehicles, pedestrians, etc.) from arbitrary image sources may be used to train the machine learning model. While the 3D points generated by the machine learning model may not be directly representative of the foreground objects in the scene, the generated 3D points may provide a sufficiently stable initial representation of the objects so as to enable the subsequent learning of the composite spatial-temporal Gaussian representations, as described in further detail below.

According to some embodiments, 3D point cloud reconstruction software may be used to generate the 3D points representative of the foreground objects (instead of using a trained machine learning model), and a trained machine learning model may be used to generate the 3D points representative of the background scene (instead of using 3D point cloud reconstruction software).

At block 205, the 3D background points generated at block 203 are passed to a background 3D Gaussian splatting model with learnable parameters, including position parameters, rotation parameters, scale parameters, opacity parameters and spherical harmonics parameters. The background 3D Gaussian splatting model is configured to transform the position and color values of each 3D background point into corresponding initial position and color values for the position parameter and the spherical harmonics parameter of each 3D Gaussian.

At blocks 206-1-206-n, the 3D foreground points generated at block 204 are passed to a number n of foreground 3D Gaussian splatting models with learnable parameters, including position parameters, rotation parameters, scale parameters, opacity parameters and spherical harmonics parameters. Each foreground 3D Gaussian splatting model is configured to learn the parameters of a single one of the n foreground objects. Furthermore, each foreground 3D Gaussian splatting model is configured to transform the position and color values of each 3D foreground point into corresponding initial position and color values for the position parameter and the spherical harmonics parameter of each 3D Gaussian.

Meanwhile, the values of the rotation parameters may be set to a predetermined value, such as [1, 0, 0, 0], the values of the scale parameters may be set to the distances between 3D points, and the values of the opacity parameters may be set to a predetermined value, such as 0.1.

At block 208, viewpoint (or “pose”) data associated with each input image is passed to a viewpoint encoding layer which encodes the viewpoint data associated with each image as a vector. The viewpoint data may include data relating to both the position of the camera that captured the image, as well as the direction in which the camera that captured the image was pointing.

At block 210, the temporal information associated with each image is passed to a time encoding layer which encodes the temporal data associated with each image as a vector.

At block 212, the 3D Gaussians (for both the background scene and the foreground objects) generated at blocks 205 and 206-1-206-n are received at a position encoding layer which encodes the spatial information associated with each Gaussian as a vector.

Each encoding layer (viewpoint encoding layer 208, time encoding layer 210, and position encoding layer 212) is configured to apply a periodic encoding function with sine and cosine functions. In particular, time encoding layer 210 uses the periodic encoding function to transform the timestamp of each frame into a temporal encoding vector; position encoding layer 212 uses the periodic encoding function to transform the position parameter of each 3D Gaussian into a spatial encoding vector; and viewpoint encoding layer 208 uses the periodic encoding function to transform the camera's position and the camera's direction into a viewpoint encoding vector. For each 3D Gaussian relating to the background scene, the time encoding vector is then concatenated with the position encoding vector. Likewise, for each 3D Gaussian relating to a foreground object, the time encoding vector is also concatenated with the position encoding vector.

At block 213, for each 3D Gaussian relating to the background scene, the concatenated vector is passed to a background spatial-temporal embedding layer configured to learn unified spatial-temporal Gaussian embeddings, based on the concatenated vector. In the present embodiment, the background spatial-temporal embedding layer comprises a two-layer neural network (or two-layer “perceptron”). In particular, the architecture of the neural network comprises a sequential arrangement of a linear layer, a rectified linear unit (ReLU) layer, and another linear layer.

At block 214, for each 3D Gaussian relating to a foreground object, the concatenated vector is passed to a foreground spatial-temporal embedding layer configured to learn unified spatial-temporal Gaussian embeddings, based on the concatenated vector. In the present embodiment, the foreground spatial-temporal embedding layer comprises a two-layer neural network (or two-layer “perceptron”). In particular, the architecture of the neural network comprises a sequential arrangement of a linear layer, a rectified linear unit (ReLU) layer, and another linear layer.

The output of background spatial-temporal embedding layer 213 is passed to a number of different background offset layers, including a position offset layer (block 215a), a scale offset layer (block 215b), a rotation offset layer (block 215c), and an opacity offset layer (block 215d). Each of these offset layers comprises a two-layer neural network (or two-layer “perceptron”). In particular, the architecture of each neural network comprises a sequential arrangement of a linear layer, a rectified linear unit (ReLU) layer, and another linear layer. Each background offset layer is configured to learn the offset of the respective parameter of each 3D Gaussian across time.

In addition, at block 215e, the output of the viewpoint encoding layer is passed to a spherical harmonic layer that also comprises a two-layer neural network (or two-layer “perceptron”). In particular, the architecture of the neural network comprises a sequential arrangement of a linear layer, a rectified linear unit (ReLU) layer, and another linear layer. Spherical harmonic layer 215e is configured to learn the offset of the color of each 3D Gaussian.

Similarly, the output of foreground spatial-temporal embedding layer 214 is passed to a number of different foreground offset layers, including a position offset layer (block 216a), a scale offset layer (block 216b), a rotation offset layer (block 216c), and an opacity offset layer (block 216d). Each of these offset layers comprises a two-layer neural network (or two-layer “perceptron”). In particular, the architecture of each neural network comprises a sequential arrangement of a linear layer, a rectified linear unit (ReLU) layer, and another linear layer. Each foreground offset layer is configured to learn the offset of the respective parameter of each 3D Gaussian across time.

In addition, at block 216e, the output of the viewpoint encoding layer is passed to a spherical harmonic layer that also comprises a two-layer neural network (or two-layer “perceptron”). In particular, the architecture of the neural network comprises a sequential arrangement of a linear layer, a rectified linear unit (ReLU) layer, and another linear layer. Spherical harmonic layer 215e is configured to learn the offset of the color of each 3D Gaussian.

The output of each offset layer 215a-e is passed to a respective residual connection that adds the learned offset to the respective parameter learned by background 3D Gaussian splatting model 205. The output of the residual connections is a composite spatial-temporal Gaussian representation of the background of the scene (block 218).

The output of each offset layer 216a-e is passed to a respective residual connection that adds the learned offset to the respective parameter learned by foreground 3D Gaussian splatting models 206-1-206-n. The output of the residual connections is a composite spatial-temporal Gaussian representation of the foreground objects in the scene (block 218).

At block 220, the composite spatial-temporal Gaussian representation is then passed to a rendering module (such as a conventional Gaussian differentiable rasterizer) which renders a video of the scene. The final output, at block 222, is a rendered video of the scene that is based on the original set of input images (block 202).

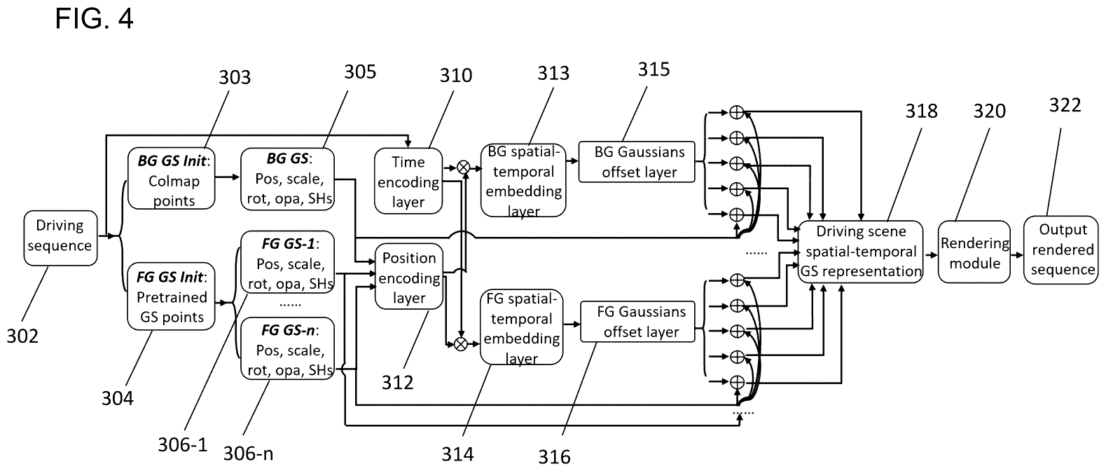

Turning to FIG. 4, there is shown a variant of the architecture described above in connection with FIG. 3. In particular, unlike the architecture described in connection with FIG. 3, no viewpoint encoding layer is used to model the viewpoint differences that are in turn used to learn the offset of the spherical harmonics. In addition, instead of using a different offset layer to learn the offset for each different type of Gaussian parameter, unified offset layers are used to learn the offsets for all Gaussian parameters. This approach may allow for the learning of a unified model that represents foreground objects and the background scene independently of viewpoint differences. Without consideration of viewpoint differences, the model may develop a unified representation suitable for all viewpoints. Moreover, the use of unified offset layers may allow the model to comprehensively learn information from all Gaussian parameters to effectively generate offsets.

At block 302, a set of images of the scene (such as a driving scene) is received. Each image contains both spatial information of the scene and temporal information of the scene. For example, each image may be associated with a timestamp, and the timestamps between successive images may indicate the amount of time that elapsed between when the images were captured.

At block 303, the set of images are inputted to 3D point cloud reconstruction software, such as COLMAP, VisualSFM, or OpenMVG. The 3D point cloud reconstruction software generates a set of 3D points, based on the images, that approximate a 3D model of the background of the scene represented by the images.

Unlike the architecture described in FIG. 2, in FIG. 3, the 3D point cloud reconstruction software generates only background points relating to the background of the scene (block 303), whereas foreground points relating to foreground objects (block 304) are generated using a machine learning model. As described above in connection with FIG. 2, in order for the machine learning model to generate 3D points representative of foreground objects, multi-view images of objects within specific categories (e.g., vehicles, pedestrians, etc.) from arbitrary image sources may be used to train the machine learning model. While the 3D points generated by the machine learning model may not be directly representative of the foreground objects in the scene, the generated 3D points may provide a sufficiently stable initial representation of the objects so as to enable the subsequent learning of the composite spatial-temporal Gaussian representations, as described in further detail below.

According to some embodiments, 3D point cloud reconstruction software may be used to generate the 3D points representative of the foreground objects (instead of using a trained machine learning model), and a trained machine learning model may be used to generate the 3D points representative of the background scene (instead of using 3D point cloud reconstruction software).

At block 305, the 3D background points generated at block 303 are passed to a background 3D Gaussian splatting model with learnable parameters, including position parameters, rotation parameters, scale parameters, opacity parameters and spherical harmonics parameters. The background 3D Gaussian splatting model is configured to transform the position and color values of each 3D background point into corresponding initial position and color values for the position parameter and the spherical harmonics parameter of each 3D Gaussian.

At blocks 306-1-306-n, the 3D foreground points generated at block 304 are passed to a number n of foreground 3D Gaussian splatting models with learnable parameters, including position parameters, rotation parameters, scale parameters, opacity parameters and spherical harmonics parameters. Each foreground 3D Gaussian splatting model is configured to learn the parameters of a single one of the n foreground objects. In addition, each foreground 3D Gaussian splatting model is configured to transform the position and color values of each 3D foreground point into corresponding initial position and color values for the position parameter and the spherical harmonics parameter of each 3D Gaussian.

Meanwhile, the values of the rotation parameters may be set to a predetermined value, such as [1, 0, 0, 0], the values of the scale parameters may be set to the distances between 3D points, and the values of the opacity parameters may be set to a predetermined value, such as 0.1.

At block 310, the temporal information associated with each image is passed to a time encoding layer which encodes the temporal data associated with each image as a vector.

At block 312, the 3D Gaussians (for both the background scene and the foreground objects) generated at blocks 305 and 306-1-306-n are received at a position encoding layer which encodes the spatial information associated with each Gaussian as a vector.

Each encoding layer (time encoding layer 310 and position encoding layer 312) is configured to apply a periodic encoding function with sine and cosine functions. In particular, time encoding layer 310 uses the periodic encoding function to transform the timestamp of each frame into a temporal encoding vector, and position encoding layer 312 uses the periodic encoding function to transform the position parameter of each 3D Gaussian into a spatial encoding vector. For each 3D Gaussian relating to the background scene, the time encoding vector is then concatenated with the position encoding vector. Likewise, for each 3D Gaussian relating to a foreground object, the time encoding vector is also concatenated with the position encoding vector.

At block 313, for each 3D Gaussian relating to the background scene, the concatenated vector is passed to a background spatial-temporal embedding layer configured to learn unified spatial-temporal Gaussian embeddings, based on the concatenated vector. In the present embodiment, the background spatial-temporal embedding layer comprises a two-layer neural network (or two-layer “perceptron”). In particular, the architecture of the neural network comprises a sequential arrangement of a linear layer, a rectified linear unit (ReLU) layer, and another linear layer.

At block 314, for each 3D Gaussian relating to a foreground object, the concatenated vector is passed to a foreground spatial-temporal embedding layer configured to learn unified spatial-temporal Gaussian embeddings, based on the concatenated vector. In the present embodiment, the foreground spatial-temporal embedding layer comprises a two-layer neural network (or two-layer “perceptron”). In particular, the architecture of the neural network comprises a sequential arrangement of a linear layer, a rectified linear unit (ReLU) layer, and another linear layer.

The output of background spatial-temporal embedding layer 313 is passed to a unified background offset layer 315 which comprises a two-layer neural network (or two-layer “perceptron”). In particular, the architecture of the neural network comprises a sequential arrangement of a linear layer, a rectified linear unit (ReLU) layer, and another linear layer. Unified background offset layer 315 is configured to learn the offset of each parameter of each background 3D Gaussian across time.

Similarly, the output of foreground spatial-temporal embedding layer 314 is passed to a unified foreground offset layer 316 which comprises a two-layer neural network (or two-layer “perceptron”). In particular, the architecture of the neural network comprises a sequential arrangement of a linear layer, a rectified linear unit (ReLU) layer, and another linear layer. Unified background offset layer 316 is configured to learn the offset of each parameter of each foreground 3D Gaussian across time.

Generally, using unified offset layers will assist with parameter convergence, whereas using an offset layer for each parameter will assist with offset diversity.

The output of background unified offset layer 315 is passed to a respective residual connection that adds the learned offsets to the parameters learned by background 3D Gaussian splatting model 305. The output of the residual connections is a composite spatial-temporal Gaussian representation of the background of the scene (block 318).

The output of foreground unified offset layer 316 is passed to a respective residual connection that adds the learned offsets to the parameters learned by foreground 3D Gaussian splatting models 306-1-306-n. The output of the residual connections is a composite spatial-temporal Gaussian representation of the foreground objects in the scene (block 318).

At block 320, the composite spatial-temporal Gaussian representation is then passed to a rendering module (such as a conventional Gaussian differentiable rasterizer) which renders a video of the scene. The final output, at block 322, is a rendered video of the scene that is based on the original set of input images (block 302).

The decision of whether or not to use unified offset layers (as opposed to a separate offset layer for each learnable parameter), whether or not to use a viewpoint encoding layer, and whether or not to separately model the background and foreground elements of the scene may be independent of one another. For example, the architecture of FIG. 4 may be modified such that a viewpoint encoding layer is used and such that the background and foreground elements are modelled as a whole (instead of separately).

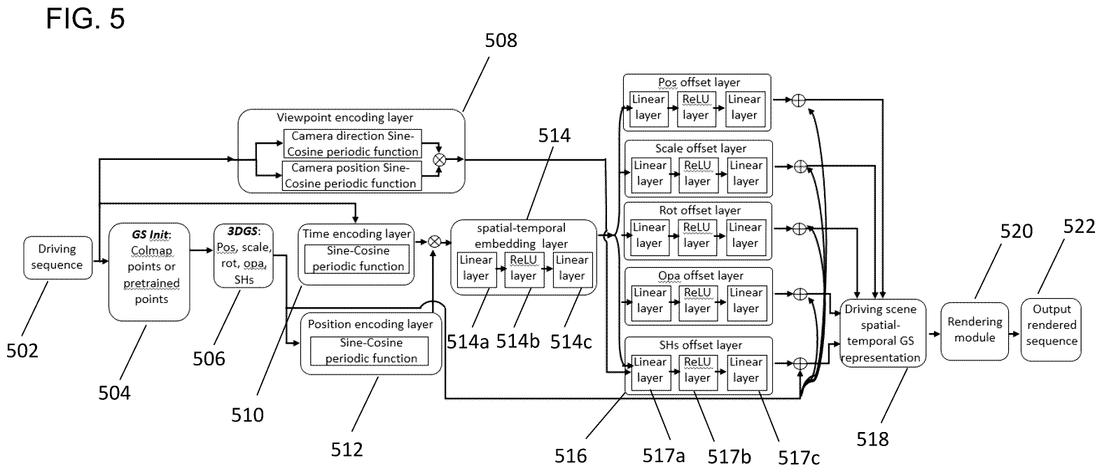

FIG. 5 illustrates the same elements of the architecture as shown in FIG. 2, but this time showing the individual layers of spatial-temporal embedding layer 514 and offset layers 516. In particular, spatial-temporal embedding layer 514 includes a linear arrangement of a first linear layer 514a, an ReLU layer 514b, and a second linear layer 514c. Similarly, each offset layer 516 includes a linear arrangement of a first linear layer 517a, an ReLU layer 517b, and a second linear layer 517c.

According to some embodiments, instead of multi-layer perceptrons, other types of neural networks may be used, such as transformers.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of rendering video of a scene, comprising:
receiving a set of images of the scene, wherein each image comprises temporal data and spatial data relating to the scene;
generating, based on the spatial data of each image, three-dimensional (3D) Gaussian splatting data;
inputting the temporal data of each image and the 3D Gaussian splatting data to a neural network to generate spatial-temporal 3D Gaussian embeddings;
generating offset data based on the spatial-temporal 3D Gaussian embeddings; and
rendering the video of the scene based on the 3D Gaussian splatting data and the offset data.

2. The method of claim 1, wherein rendering the video of the scene comprises:
combining the 3D Gaussian splatting data with the offset data to generate spatial-temporal 3D Gaussian representations of the scene; and
rendering the video of the scene by inputting the spatial-temporal 3D Gaussian representations to a rasterizer.

3. The method of claim 1, wherein generating the 3D Gaussian splatting data comprises generating the 3D Gaussian splatting data using 3D point cloud reconstruction.

4. The method of claim 1, wherein generating the 3D Gaussian splatting data comprises inputting the spatial data of each image to a machine learning model trained to generate 3D Gaussian splatting data based on spatial data from one or more images.

5. The method of claim 1, wherein:
each image further comprises viewpoint data of the scene; and
generating the offset data is further based on the viewpoint data.

6. The method of claim 5, wherein generating the offset data comprises inputting the viewpoint data to a neural network to generate one or more spherical harmonics offset parameters.

7. The method of claim 1, wherein the neural network is a multi-layer perceptron.

8. The method of claim 1, wherein generating the offset data comprises inputting the spatial-temporal 3D Gaussian embeddings to one or more neural networks.

9. The method of claim 8, wherein at least one of the one or more neural networks is a multi-layer perceptron.

10. The method of claim 8, wherein each of the one or more neural networks is a multi-layer perceptron.

11. The method of claim 1, wherein:
generating the 3D Gaussian splatting data comprises generating one or more of: one or more 3D Gaussian position parameters; one or more 3D Gaussian scale parameters; one or more 3D Gaussian rotation parameters; and one or more 3D Gaussian opacity parameters; and
generating the offset data comprises inputting one or more of:
the one or more 3D Gaussian position parameters to a neural network to generate one or more position offset parameters;
the one or more 3D Gaussian scale parameters to a neural network to generate one or more scale offset parameters;
the one or more 3D Gaussian rotation parameters to a neural network to generate one or more rotation offset parameters; and
the one or more 3D Gaussian opacity parameters to a neural network to generate one or more opacity offset parameters.

12. The method of claim 1, wherein generating the 3D Gaussian splatting data comprises:
identifying, within the spatial data of each image:
foreground spatial data relating a foreground of the scene; and
background spatial data relating a background of the scene;
generating, based on the background spatial data, background 3D Gaussian splatting data; and
generating, based on the foreground spatial data, foreground 3D Gaussian splatting data.

13. The method of claim 12, wherein generating the spatial-temporal 3D Gaussian embeddings comprises:
generating background spatial-temporal 3D Gaussian embeddings based on the temporal data of each image and the background 3D Gaussian splatting data; and
generating foreground spatial-temporal 3D Gaussian embeddings based on the temporal data of each image and the foreground 3D Gaussian splatting data.

14. The method of claim 13, wherein generating the offset data comprises:
generating background offset data based on the background spatial-temporal 3D Gaussian embeddings; and
generating foreground offset data based on the foreground spatial-temporal 3D Gaussian embeddings.

15. The method of claim 14, wherein rendering the video of the scene comprises:
combining the background 3D Gaussian splatting data with the background offset data to generate spatial-temporal 3D Gaussian representations of the background of the scene;
combining the foreground 3D Gaussian splatting data with the foreground offset data to generate spatial-temporal 3D Gaussian representations of the foreground of the scene; and
rendering the video of the scene by inputting the spatial-temporal 3D Gaussian representations of the background and the foreground of the scene to the rasterizer.

16. The method of claim 14, wherein:
generating the background offset data comprises inputting the background spatial-temporal 3D Gaussian embeddings to a single neural network to generate the background offset data; and
generating the foreground offset data comprises inputting the foreground spatial-temporal 3D Gaussian embeddings to a single neural network to generate the foreground offset data.

17. The method of claim 1, wherein generating the offset data comprises inputting the spatial-temporal 3D Gaussian embeddings to a single neural network to generate the offset data.

18. A non-transitory, computer-readable medium storing computer program code configured, when executed by one or more processors, to cause the one or more processors to perform a method comprising:
receiving a set of images of a scene, wherein each image comprises temporal data and spatial data relating to the scene;
generating, based on the spatial data of each image, three-dimensional (3D) Gaussian splatting data;
inputting the temporal data of each image and the 3D Gaussian splatting data to a neural network to generate spatial-temporal 3D Gaussian embeddings;
generating offset data based on the spatial-temporal 3D Gaussian embeddings; and
rendering the video of the scene based on the 3D Gaussian splatting data and the offset data.

19. A computing device comprising one or more graphics processors operable to render video of a scene by:
receiving a set of images of a scene, wherein each image comprises temporal data and spatial data relating to the scene;
generating, based on the spatial data of each image, three-dimensional (3D) Gaussian splatting data;
inputting the temporal data of each image and the 3D Gaussian splatting data to a neural network to generate spatial-temporal 3D Gaussian embeddings;
generating offset data based on the spatial-temporal 3D Gaussian embeddings; and
rendering the video of the scene based on the 3D Gaussian splatting data and the offset data.
